(19) United States
(12) Patent Application Publication
(10) Pub. No.: US 2018/0025794 A1
(43) Pub. Date: Jan. 25, 2018

(54) SPRAY METHODS FOR COATING NUCLEAR FUEL RODS TO ADD CORROSION RESISTANT BARRIER

(71) Applicants: WESTINGHOUSE ELECTRIC COMPANY LLC, CRANBERRY TOWNSHIP, PA (US); WISCONSIN ALUMNI RESEARCH FOUNDATION, MADISON, WI (US)

(72) Inventors: EDWARD J. LAHODA, EDGEWOOD, PA (US); PENG XU, COLUMBIA, SC (US); ZESES KAROUTAS, LEXINGTON, SC (US); SIMON MIDDLEBURGH, VASTERAS (SE); SUMIT RAY, COLUMBIA, SC (US); KUMAR SRIDHARAN, MADISON, WI (US); BENJAMIN MAIER, WAUNAKEE, WI (US); GREG JOHNSON, MADISON, WI (US)

(73) Assignees: WESTINGHOUSE ELECTRIC COMPANY LLC, CRANBERRY TOWNSHIP, PA (US); WISCONSIN ALUMNI RESEARCH FOUNDATION, MADISON, WI (US)

(21) Appl. No.: 15/284,182

(22) Filed: Oct. 3, 2016

Related U.S. Application Data
(60) Provisional application No. 62/365,632, filed on Jul. 22, 2016.

(51) Int. Cl. G21C 3/07; C23C 4/11; C23C 4/134; G21C 21/02; C23C 24/04; C22C 27/04; C22C 30/02; C22F 1/18; C23C 4/073; C23C 4/18

(52) U.S. Cl. CPC G21C 3/07; C23C 4/073; C23C 4/11; C23C 4/134; C23C 4/18; C23C 24/04; C22C 27/04; C22C 30/02; C22F 1/18; G21C 21/02; G21Y 2002/103; G21Y 2004/10

(57) ABSTRACT

A method is described herein for coating the substrate of a component for use in a water cooled nuclear reactor to provide a barrier against corrosion. The method includes providing a zirconium alloy substrate; and coating the substrate with particles selected from the group consisting of metal oxides, metal nitrides, FeCrAl, FeCrAlY, and high entropy alloys. Depending on the metal alloy chosen for the coating material, a cold spray or a plasma arc spray process may be employed for depositing various particles onto the substrate. An interlayer of a different material, such as a Mo, Nb, Ta, or W transition metal or a high entropy alloy, may be positioned in between the Zr-alloy substrate and corrosion barrier layer.

### RELATED APPLICATIONS

This application claims priority from U.S. Provisional Application Ser. No. 62/365,632 filed Jul. 22, 2016 and incorporated herein by reference.

### STATEMENT REGARDING GOVERNMENT RIGHTS

This invention was made with government support under Contract No. DE-NE0008222 awarded by the Department of Energy. The U.S. Government has certain rights in this invention.

### BACKGROUND OF THE INVENTION

### 1. Field of the Invention

The invention relates to corrosion resistant coatings for nuclear fuel rod cladding, and more particularly to spray methods for depositing corrosion resistant barriers to a substrate.

### 2. Description of the Prior Art

Zirconium alloys rapidly react with steam at temperatures of 1100° C. and above to form zirconium oxide and hydrogen. In the environment of a nuclear reactor, the hydrogen produced from that reaction would dramatically pressurize the reactor and would eventually leak into the containment or reactor building leading to a potentially explosive atmosphere and to a potential hydrogen detonation, which could lead to fission product dispersion outside of the containment building. Maintaining the fission product boundary is of critical importance.

There is a need for dramatically reducing the rate of reaction of steam with zirconium cladding to avoid generation of large quantities of hydrogen. There is a need to dramatically reducing the rate of reaction of steam with zirconium cladding to contain fission products.

### SUMMARY OF THE INVENTION

The method described herein addresses the problem associated with the potential reaction of steam with zirconium in a nuclear reactor. The method described herein provides a corrosion resistant coating that forms a barrier on the zirconium substrate.

In various aspects, the method of forming a corrosion barrier on a substrate of a component for use in a water cooled nuclear reactor comprises providing a zirconium alloy substrate, and coating the substrate to a desired thickness with particles selected from the group consisting of metal oxides, metal nitrides, FeCrAl, FeCrAlY, and high entropy alloys. The particles having an average diameter of 100 microns or less.

In certain aspects, when the particles are selected from the group consisting of FeCrAl, FeCrAlY, and high entropy alloys, the spraying is done using a cold spray process. In certain aspects, when the particles are selected from the group consisting of FeCrAl, and high entropy alloys, the spraying is done using a cold spray process. The particles in various aspects have an average diameter or 100 microns or less, and preferably have an average diameter of 20 microns or less.

The high entropy alloys used in the method may be a combination from 0 to 40 atomic % of four or more elements selected from a system consisting of Zr—Nb—Mo—Ti—V—Cr—Ta—W and Cu—Cr—Fe—Ni—Al—Mn wherein no one element is dominant. Exemplary high entropy alloys formed from such a combination may include Zr_{0.5}NbTiV, Al_{0.5}CuCrFeNi₂ and Mo₂NbTiV.

In certain aspects, when the particles are metal oxide or metal nitride particles, the spraying may be done using a plasma arc spray process. The metal oxide particles may be TiO₂, Y₂O₃, or Cr₂O₃, or any combination thereof. In various aspects, the metal oxide particles may be TiO₂, Y₂O₃, or any combination thereof. The metal nitride particles may be TiN, CrN, or ZrN, or any combination thereof.

In various aspects, the method described herein may be used for coating a zirconium (Zr) alloy substrate, such as a cylindrical or tubular substrate for use in a water cooled nuclear reactor. The method may include obtaining the Zr alloy substrate having a cylindrical surface, using a cold spray with nitrogen (N), hydrogen (H), argon (Ar), carbon dioxide (CO₂), or helium (He) gas to deposit a coating selected from the group consisting of iron chromium alumina (FeCrAl) powder, and iron chromium alumina yttrium (FeCrAl/Y) and various high entropy alloy powders on the Zr alloy substrate. The thickness of the coating may be any desired thickness, such as, but not limited to, a thickness of about 5 to 100 microns.

In various aspects, the method of coating a substrate as described herein may also include obtaining the substrate having a surface, using a plasma arc spray to deposit a coating onto the surface of the substrate. The coating may be formed from a metal oxide or metal nitride. Exemplary metal oxides include TiO₂, Y₂O₃, and Cr₂O₃ and combinations thereof. Exemplary metal nitrides include TiO₂, Y₂O₃, and Cr₂O₃ and combinations thereof. The substrate may be formed from a Zr alloy.

In various aspects, the method described herein produces a cladding tube for use in a water cooled nuclear reactor that comprises a cladding tube formed from a zirconium alloy that has a coating of up to 100 microns thick, wherein the coating is selected from the group consisting of metal oxides, metal nitrides, FeCrAl, FeCrAlY, and a high entropy alloys.

An interlayer between the coatings and substrate can be deposited to prevent or to mitigate diffusion of coating material into the substrate or to manage thermal stresses, or for both diffusion and thermal stress control. For example, in various aspects where the coating is formed from particles of FeCrAl, FeCrAlY, or combinations thereof, molybdenum (Mo) is a suitable choice for the interlayer. In general, the interlayer material may be chosen from those materials having a eutectic melting point with the zirconium or zirconium alloys that is in various aspects, above 1400° C., and preferably in certain aspects, above 1500° C., and may in addition, be chosen from those materials having thermal expansion coefficients and elastic modulus coefficients compatible with the zirconium or zirconium alloy on which it is coated and the coating which is applied above it. Examples include transition metals and high entropy alloy materials as described herein.

### BRIEF DESCRIPTION OF THE DRAWINGS

The characteristics and advantages of the present disclosure may be better understood by reference to the accompanying figures.

FIG. 1 is a schematic illustration of a cold spray process.

FIG. 2 is a schematic of a plasma arc process.

### DESCRIPTION OF THE PREFERRED EMBODIMENTS

As used herein, the singular form of “a”, “an”, and “the” include the plural references unless the context clearly dictates otherwise. Thus, the articles “a” and “an” are used herein to refer to one or to more than one (i.e., to at least one) of the grammatical object of the article. By way of example, “an element” means one element or more than one element.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Further, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

An improved method has been developed that deposits particles onto the surface of a substrate. While the method may be used for a number of substrates, it is particularly suited to coating substrates to be used as components in nuclear reactors, and more specifically, zirconium alloy substrates, such as fuel rod cladding tubes used in water cooled nuclear reactors.

In various aspects, a method of forming a corrosion resistant boundary on a substrate of a component for use in a water cooled nuclear reactor comprises providing a zirconium alloy substrate, and coating the substrate to a desired thickness with particles selected from the group consisting of metal oxides, metal nitrides, FeCrAl, FeCrAlY, and high entropy alloys, the particles having an average diameter of 100 microns or less.

The metal oxide, metal nitride, FeCrAl, FeCrAlY, or high entropy alloy particles used in the method have an average diameter 100 microns or less, and preferably have an average diameter of 20 microns or less. By average diameter, as used herein, those skilled in the art will recognize that the particles may not be spherical so that the “diameter” will be the longest dimension of the regularly or irregularly shaped particles, and the average diameter means that there will be some variation in the largest dimension of any given particle above or below 100 microns, but the average of the longest dimension of all particles used in the coating are together, 100 microns or less, and preferably the average of the longest dimension of all particles used in the coating are together 20 microns or less.

The coating step used in the method may by cold spray or by a plasma arc spray.

In certain aspects, when the particles are selected from the group consisting of FeCrAl, FeCrAlY, and high entropy alloys, the coating is preferably done using a cold spray process. In certain aspects, when the particles are selected from the group consisting of FeCrAl and high entropy alloys, the coating is preferably done using a cold spray process.

High entropy alloys, as used herein, are a class of alloys that contain four or more elements where no single element can be said to be dominant. High entropy alloys as used herein refer to those alloys based on Zr—Nb—Mo—Ti—V—Cr—Ta—W, and Cu—Cr—Fe—Ni—Al—Mn system whereby four or more of these elements can be combined from 0-40 atomic % to produce alloys such as Zr_{0.5} NbTiV, Al_{0.5}CuCrFeNi₂ and Mo₂NbTiV. High entropy alloys can be tailored to provide the best properties for a given application, such as, for example, thermal expansion matching that of the substrate, corrosion and neutron cross section.

The cold spray method may proceed by delivering a carrier gas to a heater where the carrier gas is heated to a temperature sufficient to maintain the gas at a desired temperature, for example, from 100° C. to 1200° C., after expansion of the gas as it passes through the nozzle. In various aspects, the carrier gas may be pre-heated to a temperature between 200° C. and 1200° C., with a pressure, for example, of 5.0 MPa. In certain aspects, the carrier gas may be pre-heated to a temperature between 200° C. and 1000° C., or in certain aspects, 300° C. and 900° C. and in other aspects, between 500° C. and 800° C. The temperature will depend on the Joule-Thomson cooling coefficient of the particular gas used as the carrier. Whether or not a gas cools upon expansion or compression when subjected to pressure changes depends on the value of its Joule-Thomson coefficient. For positive Joule-Thomson coefficients, the carrier gas cools and must be preheated to prevent excessive cooling which can affect the performance of the cold spray process. Those skilled in the art can determine the degree of heating using well known calculations to prevent excessive cooling. See, for example, for N₂ as a carrier gas, if the inlet temperature is 130° C., the Joule-Thomson coefficient is 0.1° C./bar. For the gas to impact the tube at 130° C. if its initial pressure is 10 bar (˜146.9 psia) and the final pressure is 1 bar (˜14.69 psia), then the gas needs to be preheated to about 9 bar*0.1° C./bar or about 0.9 C to about 130.9° C.

For example, the temperature for helium gas as the carrier is preferably 450° C. at a pressure of 3.0 to 4.0 MPa, and the temperature for nitrogen as the carrier may be 1100° C. at a pressure of 5.0 MPa, but may also be 600° C.-800° C. at a pressure of 3.0 to 4.0 MPa. Those skilled in the art will recognize that the temperature and pressure variables may change depending on the type of the equipment used and that equipment can be modified to adjust the temperature, pressure and volume parameters.

Suitable carrier gases are those that are inert or are not reactive, and those that particularly will not react with the particles or the substrate. Exemplary carrier gases include nitrogen (N₂), hydrogen (H₂), argon (Ar), carbon dioxide (CO₂), and helium (He).

There is considerable flexibility in regard to the selected carrier gases. Mixtures of gases may be used. Selection is driven by both physics and economics. For example, lower molecular weight gases provide higher velocities, but the highest velocities should be avoided as they could lead to a rebound of particles and therefore diminish the number of deposited particles.

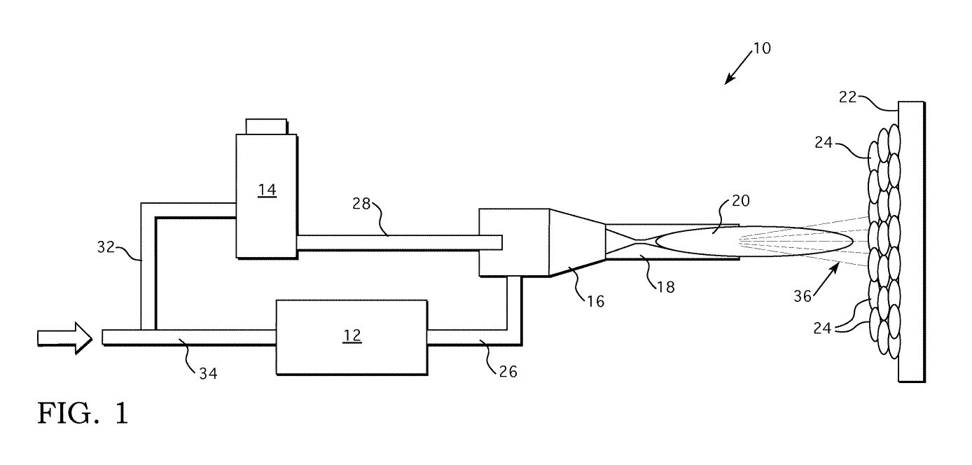

Referring to FIG. 1, a cold spray assembly 10 is shown. Assembly 10 includes a heater 12, a powder or particle hopper 14, a gun 16, nozzle 18 and delivery conduits 34, 26, 32 and 28. High pressure gas enters conduit 24 for delivery to heater 12, where heating occurs quickly; substantially instantaneously. When heated to the desired temperature, the gas is directed through conduit 26 to gun 16. Particles held in hopper 14 are released and directed to gun 16 through conduit 28 where they are forced through nozzle 18 towards the substrate 22 by the pressurized gas jet 20. The sprayed particles 36 are deposited onto substrate 22 to form a coating 30 comprised of particles 24.

The cold spray process relies on the controlled expansion of the heated carrier gas to propel the particles onto the substrate. The particles impact the substrate or a previous deposited layer and undergo plastic deformation through adiabatic shear. Subsequent particle impacts build up to form the coating. The particles may also be warmed to temperatures one-third to one-half the melting point of powder expressed in degrees Kelvin before entering the flowing carrier gas in order to promote deformation. The nozzle is rastered (i.e., sprayed in a pattern in which an area is sprayed from side to side in lines from top to bottom) across the area to be coated or where material buildup is needed.

The substrate may be any shape associated with the component to be coated. For example, the substrate may be cylindrical in shape, curved, or may be flat. Coating tubular geometries, rather than flat surfaces, has heretofore been challenging. Whereas flat surfaces can readily be coated, tubular and other curved surfaces have been economically challenging. Coating a tubular or cylindrical geometry requires the tube be rotated as the nozzle moves lengthwise across the tube or cylinder. The nozzle traverse speed and tube rotation are in synchronized motion so that uniform coverage is achieved. The rate of rotation and speed of traverse can vary substantially as long as the movement is synchronized for uniform coverage. The tube may require some surface preparation such as grinding or chemical cleaning to remove surface contamination to improve adherence and distribution of the coating.

The particles are solid particles. The particles become entrained in the carrier gas when brought together in gun 16. The nozzle 18 narrows to force the particles and gas together and to increase the velocity of the gas jet 20 exiting nozzle 18. The particles are sprayed at a velocity sufficient to provide a compact, impervious, or substantially impervious, coating layers. In various aspects the velocity of the jet spray may be from 800 to 4000 ft./sec. (about 243.84 to 1219.20 meters/sec.). The particles 24 are deposited onto the surface of the substrate at a rate sufficient to provide the desired production rate of coated tubing, at a commercial or research level.

The rate of particle deposition depends on the powder apparent density (i.e., the amount of powder vs. the air or empty space in a specific volume) and the mechanical powder feeder or hopper used to inject the powder particles into the gas stream. Those skilled in the art can readily calculate the rate of deposition based on the equipment used in the process, and can adjust the rate of deposition by altering the components that factor into the rate. In certain aspects of the method, the rate of particle deposition may be up to 1000 kg/hour. An acceptable rate is between 1 and 100 kg/hour, and in various aspects, may be between 10 and 100 kg/hour, but higher and lower rates, for example, 1.5 kg/hour, have been successfully used.

The rate of deposition is important from the standpoint of economics when more tubes can be sprayed per unit of time at higher deposition rates. The repetitive hammering of particles one after the other has a beneficial effect on improving interparticle bonding (and particle-substrate bonding) because of the longer duration of transient heating. Transient heating occurs over micro- or even nano-second time scale and over nanometer length scales. It can also result in the fragmentation and removal of nanometer thickness oxide layers that are inherently present on all powder and substrate surfaces. The spray continues until a desired thickness of the coating on the substrate surface is reached. In various aspects, a desired thickness may be several hundred microns, for example, from 100 to 300 microns, or may be thinner, for example, from 5 to 100 microns. The coating should be thick enough to form a barrier against corrosion. The coating barrier reduces, and in various aspects may eliminate any steam zirconium and air zirconium reactions, and reduces, and in various aspects eliminates, zirconium hydride formation at temperatures of about 1000° C. and above.

In certain aspects, when the particles are metal oxides, metal nitrides or combinations thereof, the spraying is preferably done by a plasma arc spray process. The metal oxide particles may be TiO₂, Y₂O₃, Cr₂O₃, or any combination thereof. In various aspects, the particles may be TiO₂, Y₂O₃ or combinations thereof. In various aspects, the particles may be a combination of TiO₂ and Cr₂O₃. In various aspects, the particles may be a combination of Y₂O₃ and Cr₂O₃. The metal nitride particles used may be TiN, CrN, or ZrN, or any combination thereof.

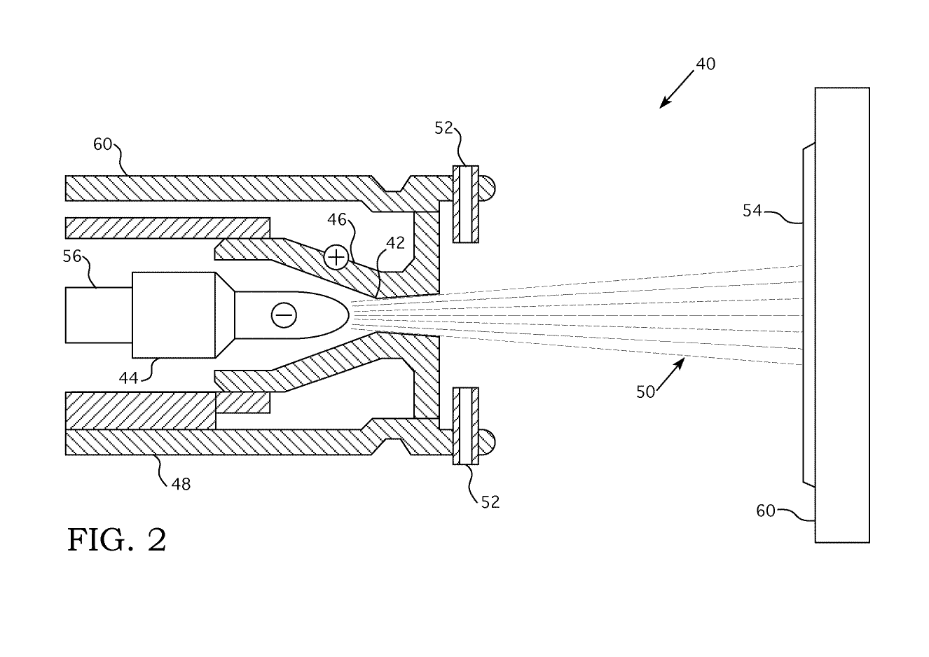

A schematic of a plasma spray process is shown in FIG. 2. A plasma torch 40 generates a hot gas jet 50. A typical plasma torch 40 includes a gas port 56, a cathode 44, an anode 46, and a water cooled nozzle 42, all surrounded by an insulator 48 in a housing 60. A high frequency arc is ignited between the electrodes, i.e., between the anode 46 and a tungsten cathode 44. A carrier gas flowing through the port 56 between the electrodes 44/46 is ionized to form a plasma plume. The carrier gas may be helium (He) hydrogen (H₂), nitrogen (N₂), or any combination thereof. The jet 50 is produced by an electric arc that heats inert the gas. The heated gas forms an arc plasma core which operates, for example, at 12,000° C. to 16,000° C. The gases expand as a jet 50 through the water cooled nozzle 42. Powders, or particles, are injected through ports 52 into the hot jet 50 where they are melted, and forced onto the substrate 60 to form a coating 54. The rate of spray may be, for example, from 2 to 10 kg/hour at a particle velocity of about 450 m/s or less. The coating thickness achieved with thermal sprays, such as plasma arc sprays, varies depending on the material sprayed, but can range, for example, from 0.05 to 5 mm. A typical thickness for the coatings described herein may be from 5 to 1000 microns, and in various aspects, the thickness of the coating may be from 10 to 100 microns.

Following the deposition of the coating 30/54 onto the substrate 22/60, the method may further include annealing the coating. Annealing modifies mechanical properties and microstructure of the coated tube. Annealing involves heating the coating in the temperature range of 200° C. to 800° C. but preferably between 350° C. to 550° C. It relieves the stresses in the coating and imparts ductility to the coating which is necessary to sustain internal pressure in the cladding. As the tube bulges, the coating should also be able to bulge. Another important effect of annealing is the deformed grains formed for example during cold spray process get recrystallized to form fine sub-micron sized equiaxed grains which may be beneficial for isotropic properties and radiation damage resistance.

The coated substrate may also be ground, buffed, polished, or otherwise further processed following the coating or annealing steps by any of a variety of known means to achieve a smoother surface finish.

In various aspects of the methods described herein, there may be an interlayer material positioned between the corrosion barrier coating and the zirconium-alloy substrate to prevent or mitigate inter-diffusion of the corrosion barrier coating material and the Zr or Zr alloy, and/or to manage thermal stresses. The plasma arc deposition process or the cold spray process described previously herein may be used for forming on the exterior of the substrate the interlayer using interlayer particles prior to deposition of corrosion barrier coating on the substrate so as to position the interlayer between the substrate and the coating. In general, the interlayer material may be chosen from those materials having a eutectic melting point with the zirconium or zirconium alloys that in various aspects, is above 1400° C., and preferably in certain aspects, is above 1500° C., and may in addition have thermal expansion coefficients and elastic modulus coefficients compatible with the zirconium or zirconium alloy on which it is coated and the coating which is applied above it. Examples include transition metals and high entropy alloy materials as described herein different from the materials used for the substrate and the corrosion barrier coating. While any transition metal is believed to be suitable, exemplary transition metals include molybdenum (Mo), niobium (Nb), tantalum (Ta), tungsten (W) and others.

The interlayer may be formed by coating the substrate with, for example, Mo particles having a diameter of 100 microns or less, with an average particle size of 20 microns or less in diameter. The method described herein, in various aspects, may therefore include, heating a pressurized carrier gas to a temperature between 100° C. and 1200° C., and in other aspects, between 200° C. and 1000° C., adding particles, such as Mo particles, of an interlayer material to the heated carrier gas, and spraying the carrier gas and entrained particles at a velocity of 800 to 4000 ft./sec. (about 243.84 to 1219.20 meters/sec.) onto the substrate. As described above, the carrier gas may be selected from the group consisting of hydrogen (H₂), nitrogen (N₂), argon (Ar), carbon dioxide (CO₂), helium (He) and combinations thereof. A high entropy alloy composition may also provide an ample interlayer owing to the ability by known techniques to control the material properties with the alloy composition.

Following application of the interlayer, the method described herein proceeds by any of the methods described above to add the corrosion barrier coating. Thereafter, the annealing and further surface treatment steps may be carried out as previously described.

The method as described herein produces a coated substrate. In an exemplary embodiment, the method produces a cladding tube for use in a water cooled nuclear reactor. The cladding tube may be formed from a zirconium alloy. The tube substrate has a coating of a desired thickness. For example, in various aspects the thickness of the coating may be up to 100 microns. In various aspects, the thickness of the coating may be about 100 to 300 microns or more. Thinner coatings from about 50 to 100 microns thick may also be applied.

The coating is selected from the group consisting of a FeCrAl, FeCrAlY, and a high entropy alloy. The high entropy alloy is selected from the group consisting of four or more elements, each in the range of 0 to 40 atomic %, selected from a system consisting of Zr—Nb—Mo—Ti—V—Cr—Ta—W and Cu—Cr—Fe—Ni—Al—Mn wherein no one element is dominant (i.e., no one element is >50 atomic %). Thus, if one element is present at 40 at. %, the remaining elements are present in amounts totaling the remaining 60 at. %.

In various aspects, the coated substrate may have an interlayer positioned between the substrate and the coating. For example, when the barrier coating is FeCrAl(Y), the interlayer may be a layer of Mo preferably between 5 and 100 microns thick.

The present invention has been described in accordance with several examples, which are intended to be illustrative in all aspects rather than restrictive. Thus, the present invention is capable of many variations in detailed implementation, which may be derived from the description contained herein by a person of ordinary skill in the art.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative embodiments. The embodiments described herein are understood as providing illustrative features of varying detail of various embodiments of the disclosed invention; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed invention. Accordingly, it will be recognized by persons having ordinary skill in the art that various substitutions, modifications or combinations of any of the exemplary embodiments may be made without departing from the scope of the invention. In addition, persons skilled in the art will recognize, or be able to ascertain using no more than routine experimentation, many equivalents to the various embodiments of the invention described herein upon review of this specification. Thus, the invention is not limited by the description of the various embodiments, but rather by the claims.

What is claimed is:

1. A method of forming a corrosion resistant barrier on a substrate of a component for use in a water cooled nuclear reactor, the method comprising:
providing a zirconium alloy substrate;
coating the substrate to a desired thickness with particles selected from the group consisting of metal oxides, metal nitrides, FeCrAl, FeCrAlY, and high entropy alloys, the particles having an average diameter of 100 microns or less.

2. The method recited in claim 1 wherein coating comprises application of particles selected from the group consisting of metal oxides, metal nitrides, and combinations thereof, by a plasma arc spray.

3. The method recited in claim 2 wherein the metal oxide particles are selected from the group consisting of TiO₂, Y₂O₃, Cr₂O₃, and combinations thereof.

4. The method recited in claim 2 wherein the metal oxide particles are selected from the group consisting of TiO₂ and Y₂O₃ and combinations thereof.

5. The method recited in claim 2 wherein the metal nitride particles are selected from the group consisting of TiN, CrN, ZrN, and combinations thereof.

6. The method recited in claim 1 wherein coating comprises application of particles selected from the group consisting of FeCrAl, high entropy alloys, and combinations thereof, by cold spray.

7. The method recited in claim 1 wherein coating comprises application of particles selected from the group consisting of FeCrAl, FeCrAlY, high entropy alloys, and combinations thereof, by cold spray.

8. The method recited in claim 7 wherein the high entropy alloys comprise a combination from 0 to 40 atomic % of four or more elements selected from a system consisting of Zr—Nb—Mo—Ti—V—Cr—Ta—W and Cu—Cr—Fe—Ni—Al—Mn wherein no one element is dominant.

9. The method recited in claim 8 wherein the combination comprises Zr_{0.5}NbTiV.

10. The method recited in claim 8 wherein the combination comprises Al_{0.5}CuCrFeNi₂.

11. The method recited in claim 8 wherein the combination comprises Mo₂NbTiV.

12. The method recited in claim 7 wherein the cold spray comprises:
heating a pressurized carrier gas to a temperature between 100° C. and 1200° C.;
adding the particles to the heated carrier gas; and
spraying the carrier gas and entrained particles onto the substrate at a velocity of 800 to 4000 ft./sec. (about 243.84 to 1219.20 meters/sec.) to form a coating on the substrate.

13. The method recited in claim 12 wherein the carrier gas is selected from the group consisting of hydrogen, nitrogen, argon, carbon dioxide, helium and combinations thereof.

14. The method recited in claim 12 wherein the rate of particles deposition is up to 1000 kg/hour.

15. The method recited in claim 12 further comprising, following formation of the coating, annealing the coating.

16. The method recited in claim 12 further comprising, following the formation of the coating, increasing the smoothness of the coating.

17. The method recited in claim 1 wherein the desired thickness is between 5 and 100 microns.

18. The method recited in claim 1 wherein the average particle size is 20 microns or less in diameter.

19. The method recited in claim 1 further comprising forming on the exterior of the substrate an interlayer selected from the group consisting of high entropy alloys, Mo, Nb, Ta, W, and combinations thereof prior to coating with the corrosion barrier particles to position the interlayer between the substrate and the coating.

20. The method recited in claim 19 wherein the interlayer is formed by coating the substrate with Mo particles having a diameter of 100 microns or less.

21. The method recited in claim 19 wherein the interlayer is formed by a thermal deposition process.

22. The method recited in claim 21 wherein thermal deposition process is a cold spray process.

23. The method recited in claim 21 wherein the cold spray process comprises:
heating a pressurized carrier gas to a temperature between 200° C. and 1000° C.;
adding particles of an interlayer material to the heated carrier gas; and
spraying the carrier gas and entrained particles at a velocity of 800 to 4000 ft./sec. (about 243.84 to 1219.20 meters/sec.).

24. The method recited in claim 23 wherein the carrier gas is selected from the group consisting of hydrogen (H₂), nitrogen (N₂), argon (Ar), carbon dioxide (CO₂), helium (He) and combinations thereof.

25. The method recited in claim 24 wherein the interlayer particles comprise Mo particles having a diameter of 100 microns or less.

26. A cladding tube for use in a water cooled nuclear reactor comprising:
a cladding tube formed from a zirconium alloy and having a corrosion resistant coating selected from the group consisting of a metal oxides, metal nitrides, FeCrAl, FeCrAlY, a high entropy alloy, and combinations thereof.

27. The cladding tube recited in claim 26 wherein the high entropy alloy is selected from the group consisting of four or more elements selected from a system consisting of Zr—Nb—Mo—Ti—V—Cr—Ta—W and Cu—Cr—Fe—Ni—Al—Mn wherein no one element is dominant and each element is present in an amount from 0-40 atomic %.

28. The cladding tube recited in claim 26 further comprising an interlayer positioned between the zirconium alloy and the corrosion resistant coating.

29. The cladding tube recited in claim 28 wherein the interlayer is selected from the group consisting of Mo, Nb, Ta, W and mixtures thereof.

30. The cladding tube recited in claim 28 wherein the interlayer is a high entropy alloy.

31. The cladding tube recited in claim 27 wherein the corrosion resistant coating is a metal nitride selected from the group consisting of TiN, CrN, ZrN, and combinations thereof.

32. The cladding tube recited in claim 27 wherein the corrosion resistant coating is a metal oxide selected from the group consisting of TiO₂, Y₂O₃, Cr₂O₃, and combinations thereof.
